(19) United States
(12) Patent Application Publication
(10) Pub. No.: US 2008/0289231 A1
(43) Pub. Date: Nov. 27, 2008

(54) OVERMOLDED END FORM FOR FLEXIBLE CONNECTOR

(76) Inventors: Ronald D. Green, New Hudson, MI (US); Kurt Klimkiewicz, Dearborn, MI (US)

Correspondence Address: Masco Corporation, 21001 Van Born Road, Taylor, MI, 48480, US

(21) Appl. No.: 11/751,698

(22) Filed: May 22, 2007

(51) Int. Cl. G09F 3/04; B23P 11/02; G09F 3/00

(52) U.S. Cl. 40/316; 29/235

(57) ABSTRACT

An overmolded end form for flexible tubing includes windows that are formed to reduce the thickness of the end form, and increase its flexibility. The windows are spaced from each other to provide an area for display of information, such as a logo or part number.

### BACKGROUND OF THE INVENTION

This application relates to a flexible tubing having a relatively flexible overmolded end form, wherein space is provided on the end form for the provision of information.

Plumbing fixtures typically include an end fitting, such as a pipe extending into a wall, and toward a shut-off valve. This end fitting is connected to various plumbing equipment, such as a faucet, etc. by flexible tubing. Some provision is required for securing the flexible tubing to the end fitting.

It is known to provide an overmolded end form on the flexible tubing at an end to be received within the end fitting. Nuts then secure the overmolded end form to the end fitting.

There has been a good deal of design work in the field of end forms. One development that has been utilized in overmolded end forms is the provision of cut-out “windows” which extend into the body of the end form to provide a reduced thickness at several spaced locations. The windows provide more flexibility in the end form. Also, the windows support and prevent kinking at a nut and end form interface. In the known end forms that utilize such windows, the windows extend over the great majority of a circumferential extent of the end form.

### SUMMARY OF THE INVENTION

In the disclosed embodiment of this invention, there are relatively large areas provided circumferentially between spaced windows. These relatively large areas provide a space to imprint logos, part numbers, etc. The relatively large areas are provided with over 60%, and in a disclosed embodiment, over 90% of the overall circumference of the end form. In a particular disclosed embodiment, there are two spaced areas, and the total circumferential range of the two combined spaces was over 150°. In a disclosed embodiment, it approached 180°.

In another embodiment, there are two sets of larger windows, with a smaller sub-window on one circumferential side. The space for the logo, part number, or other information, is at an opposed circumferential side.

These and other features of the present invention can be best understood from the following specification and drawings, the following of which is a brief description.

### BRIEF DESCRIPTION OF THE DRAWINGS

FIG. 1 schematically shows a first plumbing installation.

FIG. 2 shows an alternative structure.

FIG. 3 is a perspective view showing a disclosed end form.

FIG. 4A is one side of a first embodiment.

FIG. 4B shows an opposed side of the first embodiment.

FIG. 5A is a cross-sectional view through the first embodiment.

FIG. 5B shows a second embodiment.

### DETAILED DESCRIPTION OF THE PREFERRED EMBODIMENT

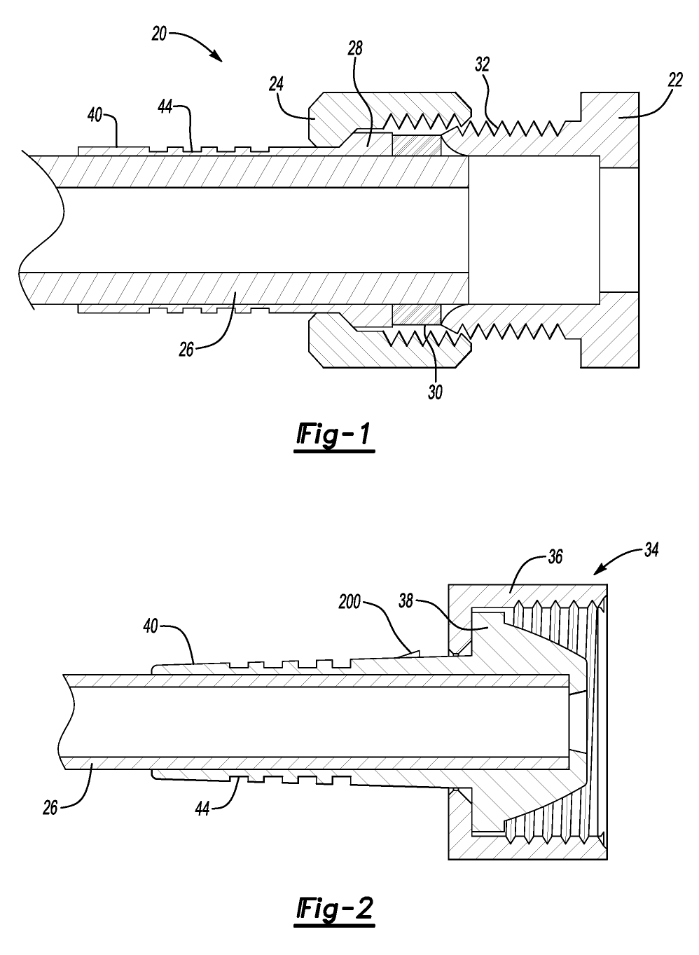

A plumbing assembly 20 is illustrated in FIG. 1. As known, an end fitting 22, such as a shut-off valve receives a nut 24. The nut 24 secures a tubing 26 by capturing a head 28 molded onto the tubing. A seal 30 may also be included. When the nut 24 is secured onto threads 32 on the end fitting 22, the nut secures the tubing 26 to the end fitting. The head 28 (or 38 in the FIG. 2 embodiment) is molded onto the tubing 26. In FIG. 2, nut 36 captures the head 28 as shown in FIG. 1. The different heads 28 and 38 as shown in FIG. 1 are merely examples. Various other shapes would come within the scope of this invention.

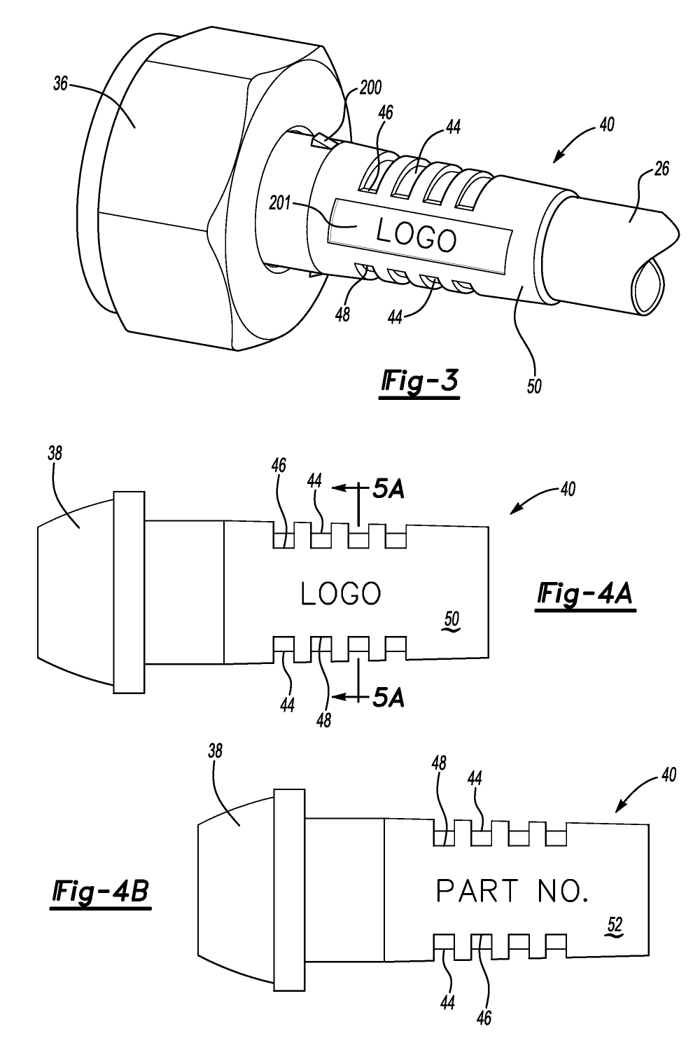

As can be appreciated from FIGS. 1-3, a series of rows of windows 44 are formed into the outer periphery of an extension section 40 of the overmolded end form. These windows 44 extend circumferentially between ends 46 and 48. The ends 46 and 48 of opposed sets of windows 44 are spaced by an area 50. The area 50 may be utilized to display information such as a logo, part number, etc. Typically, the information can be molded into the end form. As shown, a recess 201 helps highlight the information. The purpose of the windows 44 is to provide additional flexibility, support, etc. to the overmolded portion as mentioned above. Also as mentioned above, in the prior art the windows cover the great majority of the circumferential extent of the overmold end form. Retainer tab 200 holds the nut on the end form prior to assembly.

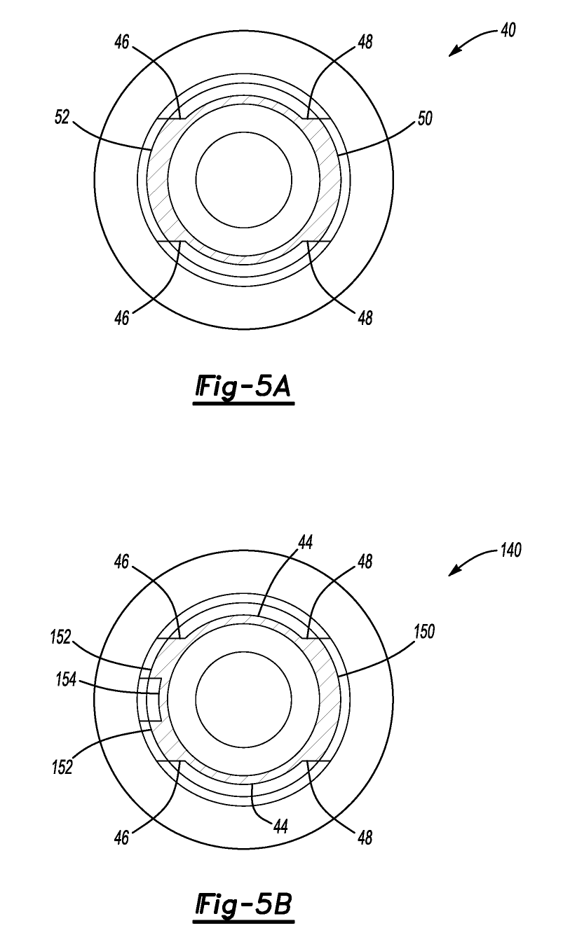

As shown in FIGS. 4A and 4B, in a first embodiment, an opposed area 52 for receiving additional information (here a part number) is formed on an opposed side from the area 50.

As shown in FIG. 5A, the combined angles over which the areas 50 and 52 extend are greater than 120°, and, in fact, approach 180°.

As shown in FIG. 5B, in a further embodiment 140, the area 150 is as shown in the first embodiment, however the opposed side 152 is actually provided with two spaced lands with an intermediate sub-window 154. With this embodiment, there is less surface area for display of information, however, the area 150 is still large enough for display of information, and the smaller areas 152 can also display information. Again, the surface area of area 152, over which information can be displayed, is still greater than 60°, and is actually approaching 90°.

As shown, the information can be raised from the nominal surface, or simply printed on the surface. Also, the number and shape of the windows is merely an example. Other numbers and shapes would come within the scope of this invention.

The end form may be molded from PEX, and onto a PEX tube. However, the invention is not limited to any particular material. In one embodiment, the overmold is injected molded onto an extruded tube to provide a bond. The product is then cross-linked by electron beaming. Other cross-linking techniques may be used. However, other methods of forming the combination would also come within the scope of this invention.

Although a nut is disclosed to secure the end form, other retention methods, such as a quick connect, may be utilized.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. A flexible tubing and overmolded end form comprising:
a flexible tubing extending generally along an axis; and
an end form molded onto the flexible tubing, said end form having a head to be captured within a retainer, and an extension portion extending away from the head, there being sets of windows formed into an outer periphery of said extension portion to reduce the thickness of the end form locally at the windows, and the windows having circumferential ends that are spaced away from each other by an area, the area displaying information.

2. The flexible tubing as set forth in claim 1, wherein displayed information includes at least one of a logo and a part number.

3. The flexible tubing as set forth in claim 1, wherein there are two sets of opposed windows spaced by areas on opposed circumferential sides.

4. The flexible tubing as set forth in claim 1, wherein there are two sets of windows, and wherein at one area between the ends of the windows, information is displayed, and at an opposed area, there is a sub-window to provide further flexibility.

5. The flexible tubing as set forth in claim 1, wherein the area for display of information extends over at least 60° of a circumferential extent of the end form about the axis.

6. The flexible tubing as set forth in claim 5, wherein the area extends over at least 120°.

7. The flexible tubing as set forth in claim 1, wherein the retainer is a nut.

8. The flexible tubing as set forth in claim 1, wherein a tab is formed on said extension portion to hold the retainer on the end form.

9. An assembly comprising:
a flexible tubing extending generally along an axis, an end form molded onto the flexible tubing; and
said end form having a head captured within a retainer, and an extension portion extending away from the head, there being sets of windows formed into an outer periphery of said extension portion to reduce the thickness of the end form locally at the windows, and the windows having circumferential ends that are spaced away from each other by an area, the area displaying information.

10. The assembly as set forth in claim 9, wherein displayed information includes at least one of a logo and a part number.

11. The assembly as set forth in claim 9, wherein there are two sets of opposed windows spaced by areas on opposed circumferential sides.

12. The assembly as set forth in claim 9, wherein there are two sets of windows, and wherein at one area between the ends of the windows, information is displayed, and at an opposed area, there is a sub-window to provide further flexibility.

13. The assembly as set forth in claim 9, wherein the area for display of information extends over at least 60° of a circumferential extent of the end form about the axis.

14. The assembly as set forth in claim 13, wherein the area extends over at least 120°.

15. The assembly as set forth in claim 9, wherein the retainer is a nut.

16. The assembly as set forth in claim 9, wherein a tab formed on said extension portion holds the retainer on the end form.
